(19) United States
(12) Patent Application Publication
(10) Pub. No.: US 2021/0033742 A1
(43) Pub. Date: Feb. 4, 2021

(54) ACOUSTIC INTEGRITY IMAGING

(71) Applicant: Halliburton Energy Services, Inc., Houston, TX (US)

(72) Inventors: David John Topping, Houston, TX (US); Freeman Lee Hill, Spring, TX (US); Darren Philip Walters, Tomball, TX (US); Srinivasan Jagannathan, Houston, TX (US)

(21) Appl. No.: 16/338,735

(22) PCT Filed: Nov. 9, 2016
(86) PCT No.: PCT/US2016/061123

§ 371 Date: Apr. 2, 2019

(51) Int. Cl. G01V 1/50; G01V 1/46; G01V 1/02; G01V 1/18; E21B 47/005

(52) U.S. Cl. CPC G01V 1/50; G01V 1/46; G01V 1/02; G01V 1/186; E21B 47/005; E21B 2200/20; G01V 2210/66; G01V 2210/74; G01V 2210/121; G01V 2210/1299; G01V 2210/1429; G01V 2210/62

(57) ABSTRACT

Various embodiments include methods and apparatus structured to investigate a structure of multiple strings of pipe in a wellbore and material around the pipes in the wellbore. An array of acoustic receivers can be used to monitor sound energy from the structure and material within and around the structure. The received sound energy can be segregated and coherent signal processing of the received sound energy can be conducted with respect to location. A bond map of the structure and regions around the multiple strings of pipe can be derived from the coherent signal processing. Additional apparatus, systems, and methods can be implemented in a variety of applications.

### TECHNICAL FIELD

The present invention relates generally to apparatus and methods related to oil and gas exploration.

### BACKGROUND

In the oil and gas industry, the generation and management of wells includes measuring the properties and events associated with the wells and the formations in which the wells are located. A number of techniques can be used to monitor and measure the properties and events associated with the wells. Increasingly, in many cases it is advantageous to evaluate the integrity of cement that is around casing strings while logging in/through tubing. In plug and abandonment and other periods of the well's life cycle, the bond condition of the cement throughout the well structure is important to know before operations begin, so that the abandonment design and compliance with regulations is efficiently met. By proper planning and direction, the high expense of rig time and un-needed costs can be saved.

### BRIEF DESCRIPTION OF THE DRAWINGS

FIGS. 1A-1C are example maps of cement coupling with respect to a well structure from acoustic responses, in accordance with various embodiments.

FIGS. 2A and 2B provide a comparison of simulations of frequency response of a borehole under two different completion scenarios, in accordance with various embodiments.

FIG. 3 is a schematic representation of a system having an array of acoustic receivers positioned within a multi-string structure of pipes in a wellbore in a formation, in accordance with various embodiments.

FIG. 4 is a flow diagram of elements of an example processor implemented method of determining status of a structure of multiple strings of pipe in a wellbore, in accordance with various embodiments.

FIG. 5 is a block diagram of features of an example system operable to execute schemes associated with determining status of a structure of multiple strings of pipe in a wellbore, in accordance with various embodiments.

### DETAILED DESCRIPTION

The following detailed description refers to the accompanying drawings that show, by way of illustration and not limitation, various embodiments in which the invention may be practiced. These embodiments are described in sufficient detail to enable those skilled in the art to practice these and other embodiments. Other embodiments may be utilized, and structural, logical, electrical, and mechanical changes may be made to these embodiments. The various embodiments are not necessarily mutually exclusive, as some embodiments can be combined with one or more other embodiments to form new embodiments. The following detailed description is, therefore, not to be taken in a limiting sense.

In various embodiments, systems and methods can be implemented to evaluate multiple strings of pipe in a wellbore using an array of acoustic receivers, where the array of acoustic receivers can be arranged relative to a structure of the multiple strings of pipe in the wellbore. Such systems and methods can be used to address cement evaluation of multiple strings of pipe. The array of acoustic receivers may be an array of highly sensitive hydrophones, or other sensitive receivers, that monitor sound energy related to the bonding of each string of casing/pipe. In addition to the array of acoustic receivers, a set of acoustic transmitters can be used and operated at a set of frequencies to determine related attenuation, impedance, or bond index of the cement coupling to the pipe. A bond index provides a quantitative assessment of a cement to pipe bond. A bond index may be taken as a ratio of signal attenuation at a location to a maximum attenuation. The set of acoustic transmitters can include one or more acoustic transmitters and the set of frequencies can include one or more frequencies.

Herein, a multi-string structure is a structure having a set of two or more strings of pipe nested within each other, the set having an innermost string of pipe and an outermost string of pipe, where the innermost string of pipes has the smallest outer diameter of the pipes of the set, the outermost string of pipes has the largest outer diameter of the pipes of the set, and the remaining strings of pipes of the set have outer diameters of value greater than the value of the outer diameter of the innermost string of pipe and less than the value of the inner diameter of the outermost string of pipe with each pipe of the set having a different outer diameter with respect to the other pipes of the set. At a point on a reference axis within the innermost string of pipe of the set in the longitudinal direction of the innermost string of pipe, a plane perpendicular to the reference axis intersects the strings of pipes of the multi-string structure. In various embodiments, a multi-string structure can be realized by a set of concentric pipes. However, a multi-string structure is not limited to a set of concentric pipes.

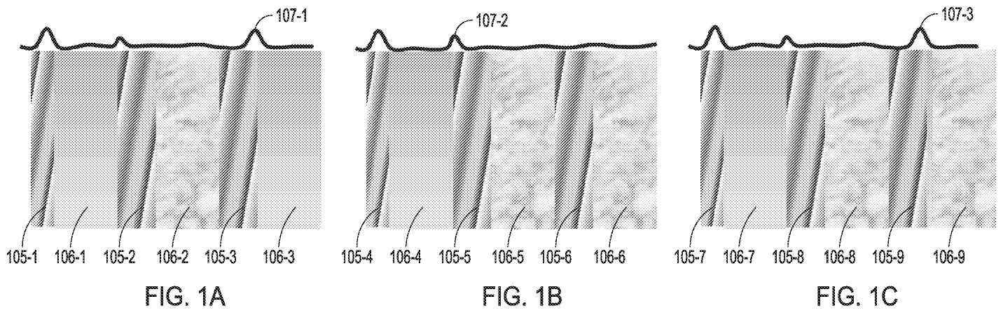

FIGS. 1A-1C are examples of maps of cement coupling with respect to a well structure from acoustic responses. A map is a representation of features of an entity showing relationships according to a convention of representation. A bond map of a structure can he realized as map of the structure with respect to quality of physical bonding of materials at interfaces between different regions of the structure. The bond map can be presented as an image with different regions shown reflecting the quality of the bonding including presence of material at an interface between two material regions that is different from the material of the two material regions. These maps of FIGS. 1A-1C can provide indications where cement is and where cement is lacking through the multiple strings.

FIG. 1A shows a portion of a cross-section of three strings of pipes 1051, 105-2, and 105-3 with each adjacent to annulus 106-1, 106-2, and 106-3, respectively, from a center region of a multi-pipe structure. The acoustic response 107-1 can indicate the nature of the annuli 106-1, 106-2, and 106-3. In this case, annulus 106-1 is a fluid filled annulus, 106-2 is an annulus having a good cement bond, and 106-3 is a fluid/gas filled annulus.

FIG. 1B shows a portion of a cross-section of three strings of pipes 105-4, 105-5, and 105-6 with each adjacent to annulus 106-4, 106-5, and 106-6, respectively, from a center region of a multi-pipe structure. The acoustic response 107-2 can indicate the nature of the annuli 106-4, 106-5, and 106-6. In this case, annulus 106-4 is a fluid filled annulus, 106-5 is an annulus having a good cement bond, and 106-6 is another annulus having a good cement bond.

FIG. 1C shows a portion of a cross-section of three strings of three pipes 105-7, 105-8, and 105-9 with each adjacent to annulus 106-7, 106-8, and 106-9, respectively, from a center region of a multi-pipe structure. The acoustic response 107-3 can indicate the nature of the annuli 106-7, 106-8, and 106-9. In this case, annulus 106-7 is a fluid filled annulus, 106-8 is an annulus having a good cement bond, and 106-9 is another annulus having a bad cement bond due to inclusion of fluid or gas 108 at an interface of pipe string 105-9 and annulus 106-9.

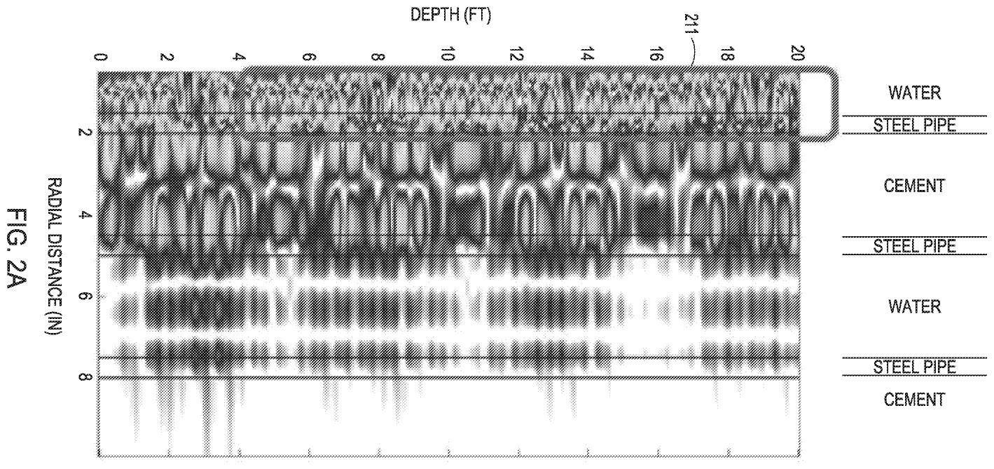

FIGS. 2A and 2B provide a comparison of simulations of frequency response of borehole under two different completion scenarios. FIG. 2A is a completion with water in the middle annulus and FIG. 2B is a completion with cement in the middle annulus. A simulated source at 0,0 generated an acoustic signal coupled into different layers: water, steel pipe, cement, steel pipe, water, steel pipe, cement in FIG. 2A and water, steel pipe, cement, steel pipe, cement, steel pipe, cement in FIG. 2B. The simulated source at 0,0 can be simulated as being in a fluid in the wellbore, where the fluid could be water, mud, drilling fluid, completion fluid, or other non-gas fluid. FIGS. 2A and 2B show the acoustic field mapped out as acoustic intensity as a function of space. Region 211 represents higher energy levels and region 213 represents lower energy levels. The simulations were conducted for a frequency of 30 kHz. As can be seen from the simulations, the frequency response in the borehole indicates more acoustic energy when one of the annulus contains water as opposed to cement. Such differences can be exploited to identify the quality of cementing in the annuli. Both time and frequency responses of acoustic receivers, such as hydrophones for example, can be used to determine the bond indices of the different layers.

As can be seen in FIGS. 2A and 2B, the frequency response of the borehole depends on the geometry and materials in the different annuli. The corresponding time response also differs for different cases of good cement bond or bad cement bond. Techniques, as taught herein, can exploit these differences through a combination of forward propagation modeling and coherent signal processing such as beamforming, possibly via a learning algorithm or via a theoretical study. Beamforming provides a mechanism to operate on responses received from multiple sensors and to create a map of where the acoustic reflections are generated.

In various embodiments, use of an acoustic array can incorporate beamforming to produce two-dimensional (2D) or three-dimensional (3D) modeling representing cement integrity throughout the wellbore structure. An acoustic transmitter or mechanical energy device can be used to excite pipe harmonics or resonance. The sound emitted or reflected by the pipe strings can give an indication of the material around the pipe strings. The material can include cement, fluid, gas, partial solids, or combinations thereof. The acoustic transmitter may emit acoustic energy in bursts or constantly. The frequencies/spectra can be monitored and segregated to reflect the pipe being sampled by distance and/or frequencies. Once segmentation has occurred, then model beamforming can occur by partitioning the sound frequency/spectra and magnitude patterns into the location being produced. Once the model beamforming has been completed, a material/bond map around multiple strings of pipe in the well's structure can be determined or implied. A log through tubing can be generated to determine binding in the first string of case, a second string of casing, and more strings of casing if the received signal is strong enough. Using an acoustic array with beamforming to detect and map cement integrity provides enhancements over that of today's conventional services.

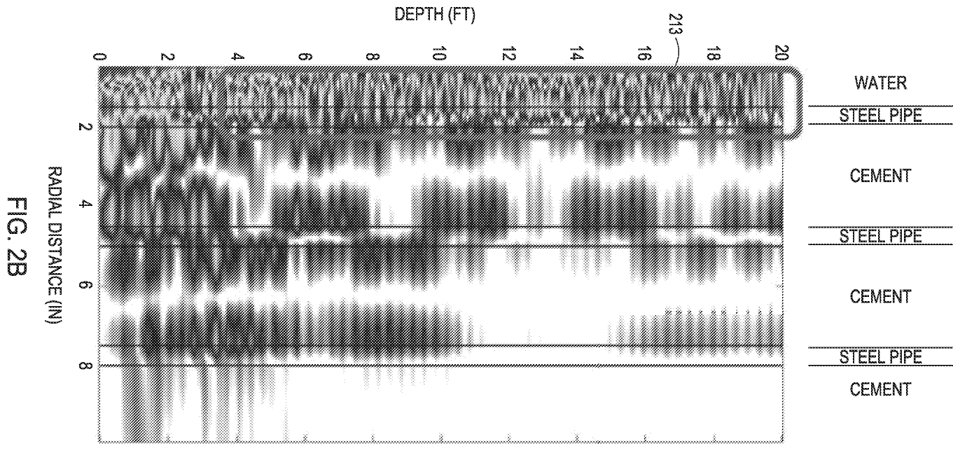

FIG. 3 is a schematic representation of a system 300 having an array of acoustic receivers 310 positioned within a multi-string structure 305 of pipes in a wellbore 303 in a formation 302, where the array of acoustic receivers 310 can be used to evaluate the status of the multiple strings 105-1, 105-2, and 105-3 and the material surrounding these strings of pipes. Around each strings 105-1, 105-2, and 105-3 are annulus 106-1, 106-2, and 106-3, respectively. Though FIG. 3 shows three strings of pipes and associated annuli, the multi-string structure 305 can have more or less than three strings of pipes and associated annuli.

The system 300 can include acoustic transmitters 315-1, 315-2, or both acoustic transmitters 315-1 and 315-2. Each of acoustic transmitters 315-1 and 315-2 can include a set of one or more acoustic transmitters. The acoustic transmitters 315-1 and/or 315-2 can be operated to excite pipe harmonics and materials within the multi-string structure 305. The acoustic transmitters 315-1 and/or 315-2 can be operated at different frequencies. The acoustic transmitters 315-1 and/or 315-2 can be activated to energize the material around the wellbore 303 and from this energy, reflections of sound that are being generated in different areas of the wellbore 303 are received by the array of acoustic receivers 310. The acoustic transmitters 315-1 and/or 315-2 can transmit acoustic pulses for which a set of acoustic signatures can be received by the array of acoustic receivers 310. The set of acoustic signatures can be inverted to determine properties between the pipes. Use of the array of acoustic receivers 310 allows for indicating from where around the wellbore these sound. events occur or are reflected back. By having such data, information about the material, which is in each one of these areas, can be attained.

The array of acoustic receivers 310 can be structured as a linear array of acoustic receivers. The type of acoustic receivers may take on a number of different formats. For example, the array of acoustic receivers 310 may be an array of hydrophones. Other types of acoustic receivers may used. For example, a fiber optic acoustic receiver arrangement can be used. A fiber optic acoustic receiver arrangement can include an array of acoustic sensors coupled to an optical fiber. The acoustic sensors coupled to the optical fiber may include electronics to power the acoustic sensors to communicate the detected sound via the optical fiber. Alternatively, each acoustic sensor can perturb the optical fiber in response to receiving the sound energy to the degree that the respective acoustic sensor detects the sound energy. Another fiber optic acoustic receiver arrangement can include an optical fiber used as a linear array of acoustic sensors, where each of a specified length of the optical fiber in the wellbore 303 is operated as an acoustic sensor in a distributed acoustic sensor (DAS) arrangement.

The array of acoustic receivers 310 can be disposed along a longitudinal axis 317 of the multi-string structure 305. The array of acoustic receivers 310 can be disposed in the multi-string structure 305 at locations other than the longitudinal axis 317. For example, the array of acoustic receivers 310 along the pipe string 305-1 can be disposed in contact with the inner surface of the pipe string 305-1. In another example, the array of acoustic receivers 310 along the pipe string 305-1 can be disposed outside of the pipe string 305-1 with the acoustic transmitters 315-1 and/or 315-2 within the pipe string 305-1. In such an arrangement, the array of acoustic receivers 310 can be in contact with the outer surface of the pipe string 305-1. The array of acoustic receivers 310 can be conveyed into the multi-string structure 305 in a slickline arrangement, a wireline arrangement, or other conventional technique such as, a coiled tubing arrangement, a drill pipe arrangement, a downhole tractor arrangement, or other appropriate arrangement. Operation of the array of acoustic receivers 310 can be run in real-time mode or in memory mode. The memory mode may be battery-operated. In the field of data processing devices, real time refers to completing some data processing within a time that is sufficient to keep up with an external process. The acoustic transmitters 315-1 and/or 315-2 may be disposed into the multi-string structure 305 along with the array of acoustic receivers 310.

The system 300 can include a controller 330. The controller 330 may be realized as a processor or a processor along with other devices to control the acoustic transmitters 315-1 and/or 315-2 and the array of acoustic receivers 310, and to process signals acquired from operation of the array of acoustic receivers 310. The controller 330 can include one or more processing devices arranged to control a number of functions of system 300. The controller 330 can include a processor arranged to operate on output of the array of acoustic receivers 310, where the processor is operable to segregate frequencies of received sound energy at the array of acoustic receivers 310 to indicate a pipe of the multi-string structure 305 being sampled by distance and/or frequencies, to conduct coherent signal processing of the received sound energy with respect to location, and to derive a bond map of the multi-string structure 305 and regions around the multiple strings of pipe of the multi-string structure 305 from completion of the coherent signal processing.

The processor of the controller 330 can be arranged to conduct coherent processing of the received sound energy with the processor operable to generate model beamforming by partitioning the frequencies and magnitude patterns of the received sound energy into locations. The processor can be arranged to determine bond indices of different regions of the structure using time and frequency responses of the array of acoustic receivers 310, such as an array of hydrophones. The processor can use forward modeling to identify material around pipes of the structure to derive a bond map. The system 300 can include a display on which to image the bond map, though not shown in FIG. 3.

The system 300 or similar system may be part of a larger system having one or more acoustic sources, an array of array of receivers, multiple layers of pipe in a wellbore, and material in annuli between the multiple layers of pipe. The acoustic tool configuration of the system 300 can be implemented to determine what is between these pipes. The system 300 or similar system can transmit an acoustic pulse or pulses to receive a set of acoustic signatures at the array of acoustic receivers 310. The transmitted pulses can be at different frequencies and have other different pulse characteristics.

Sound energy travels from the source or source(s), coupling into different layers. h is theorized that there should be different signatures in received acoustic energy depending on what is between the pipes. The system 300 or similar system can be implemented to exploit these different kinds of signatures. The data from the received acoustic energy can include time data, frequency data, spatial correlation, and other forms of data. With an array of multiple acoustic receivers, correlation of signals between the multiple acoustic receivers may provide data that can be mapped back to identification of the material between the layers of pipes.

Once signals are collected by the array of acoustic receivers, properties of the signals can be examined based on one acoustic receiver, and properties of the signals can be examined based on the multiple receivers of the array. Evaluating received signals with respect to one receiver at a time, examination can be directed, but not limited, to energy, frequency content, and time correlations. Evaluating received signals with respect to multiple receivers of the array, examination can be directed, but not limited, to spatial correlations. With responses received at multiple receivers of the array, beamforming can be conducted. Beamforming is a known signal processing technique that can be used with an array of transmitters or receivers. For instance, signals in an array of acoustic receivers may be combined such that signals at particular angles or directions experience constructive interference while others experience destructive interference. Beamforming may implement a set of weights with the signals received at the different acoustic receivers of an acoustic array.

The system 300 or similar system can be implemented to segregate the received signals at the array of acoustic receivers 310 with respect to distance and/or frequency. Magnitude of the received signal can also be analyzed including comparisons among the different receivers. The segregation may be based on the intensity of the received signals. Beamforming provides a mechanism to examine all the signals and conduct phase shifts to align the signals. Knowing what the phase shifts are, one can determine from where noise, for instance, comes. Using different frequencies from the acoustic transmitters, different distances associated with different frequencies can be analyzed. For example, for a received signal reflecting back at 10,000 Hz and one reflecting back at 15,000 Hz, one can determine two different areas that the signals came from in the wellbore based on the phase shift between these signals.

With coherent processing integrated with operation of one or more transmitters and several receivers of an array of acoustic receivers in a wellbore, forward modeling can provide a process to examine sectors around the wellbore in a directional manner. Beamforming, using the multiple receivers, also provides a process to create a map of where the sound reflections are coming from around the wellbore. The map can be a map of acoustic intensity as a function of space. In the beamforming, individual frequencies, individual time, individual spectra can be considered, providing a capability to basically slice the data from the receivers in a number of different selected formats to attain a desired sensitivity in the data.

The processing of the data, as taught herein, may be approached, as basically, being similar to forward modeling of the responses that are occurring in and around the wellbore to signals generated by the acoustic transmitters. In operation of the system 300 or similar system, the material in and around the wellbore is energized and from this energy, reflections of sound that is being generated in the different areas of the wellbore are detected in the array of acoustic receivers. From the forward modeling, determination of whether a given area is water, cement, or air can be determined. In the forward modeling, an initial model can be used for a given multi-string structure in a given wellbore. If analysis of expected received signals for this initial model does not match the received signals, the initial model can be changed and re-analyzed and compared to the received signals. Change of the model can continue until a match is made within a selected tolerance level. Changing the model can include such changes as the percent of water, mud, or other material in a selected region of the model. Once this type of modeling is conducted during the beamforming, a material bond map around the strings of pipe in the well can be generated.

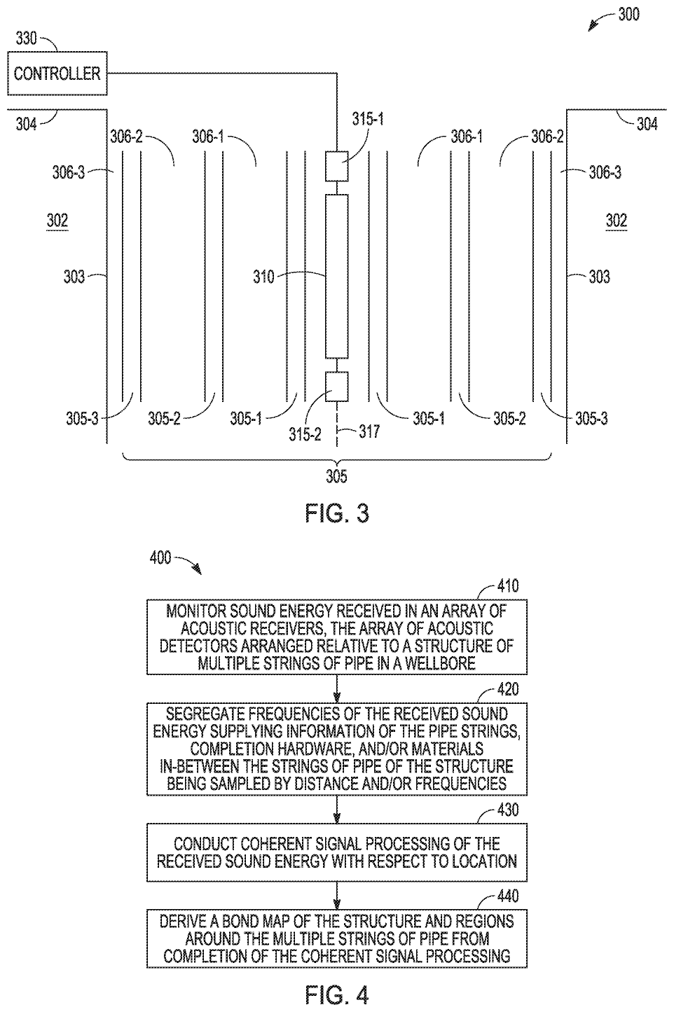

FIG. 4 is a flow diagram of elements of an embodiment of an example processor implemented method 400 of determining status of a structure of multiple strings of pipe in a wellbore. At 410, sound energy received in an array of acoustic receivers is monitored. The array of acoustic receivers can be arranged relative to a structure of multiple strings of pipe in a wellbore. The received sound energy can be sound energy derived from exciting pipe harmonics of the structure using an acoustic transmitter. Monitoring sound energy received in the linear array of acoustic receivers includes monitoring sound energy received in an array of hydrophones. Monitoring sound energy received in the array of acoustic receivers includes monitoring sound energy received in an optical fiber sensor arranged as a distributed acoustic sensor.

At 420, frequencies of the received sound energy are segregated, supplying information of the pipe strings, completion hardware, and/or materials in-between of the structure being sampled by distance and/or frequencies. At 430, coherent signal processing of the received sound energy can be conducted with respect to location. Conducting coherent processing of the received sound energy can include generating model beamforming by partitioning the frequencies and magnitude patterns of the received sound energy into locations.

At 440, a bond map of the structure and regions around the multiple strings of pipe is derived from completion of the coherent signal processing. Deriving a bond map can include using forward modeling to identify material around pipes of the structure.

The method 400 or methods similar to method 400 can include additional features. Such methods can include determining bond indices of different regions of the structure under investigation using time and frequency responses of hydrophones or other acoustic receivers. Such methods can include activating one or multiple acoustic transmitters to excite pipe harmonics and materials of the structure from which the sound energy is monitored. Activating one or more acoustic transmitters can include activating one or more acoustic transmitters with different frequencies from which the sound energy is monitored. Such methods can include imaging a bond map on a display. Additionally, the method 400 or methods similar to method 400 can include performing activities and/or using instrumentation taught herein.

In various embodiments, a non-transitory' machine-readable storage device can comprise instructions stored thereon, which, when performed by a machine, cause the machine to perform operations, the operations comprising one or more features similar to or identical to features of methods and techniques described with respect to method 400, variations thereof, and/or features of other methods taught herein such as associated with FIGS. 1-5. The physical structures of such instructions may be operated on by one or more processors. Executing these physical structures can cause the machine to perform operations comprising: monitoring sound energy received in an array of acoustic receivers, the array of acoustic receivers arranged relative to a structure of multiple strings of pipe in a wellbore; segregating frequencies of the received sound energy supplying information of the pipe strings, completion hardware, and/or materials in-between of the structure being sampled by distance and/or frequencies; conducting coherent signal processing of the received sound energy with respect to location; and deriving a bond map of the structure and regions around the multiple strings of pipe from completion of the coherent signal processing. Execution of various instructions may be realized by the control circuitry of the machine. The instructions can include instructions to operate a tool or tools having sensors (various forms of acoustic transmitters and arrays of acoustic receivers) disposed in a multi-string structure in a wellbore to provide data to process in accordance with the teachings herein.

The operations executed from the instructions can include conducting coherent processing of the received sound energy to include generating model beamforming by partitioning the frequencies and magnitude patterns of the received sound energy into locations. Monitoring sound energy received in the linear array of acoustic receivers can include monitoring sound energy received in an array of hydrophones. Monitoring sound energy received in the array of acoustic receivers can include monitoring sound energy received in an optical fiber sensor arranged as a distributed acoustic sensor. Deriving a bond map can include using forward modeling to identify material around pipes of the structure.

Machine-readable storage devices can include instructions to perform operations that can include exciting pipe harmonics of the structure using an acoustic transmitter. Operations can include determining bond indices of different regions of the structure using time and frequency responses of the hydrophones or other acoustic receivers. Operations can include activating one or multiple acoustic transmitters to excite pipe harmonics and materials of the structure from which the sound energy is monitored. Operations can include activating one or more acoustic transmitters with different frequencies from which the sound energy is monitored. Operations can include imaging the bond map on a display. Additionally, operations can include performing activities and/or using instrumentation taught herein.

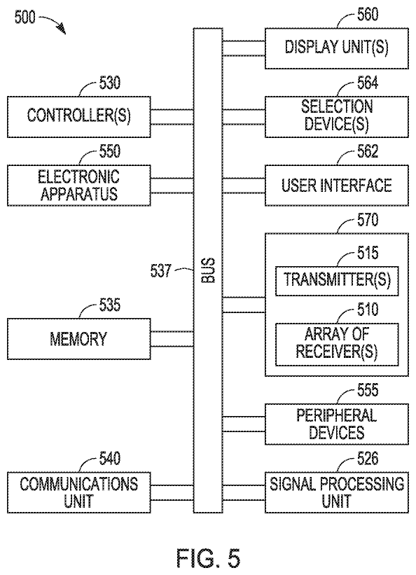

Further, a machine-readable storage device, herein, is a physical device that stores data represented by physical structure within the device. Such a physical device is a non-transitory device. Examples of machine-readable storage devices can include, but are not limited to, read only memory (ROM), random access memory (RAM), a magnetic disk storage device, an optical storage device, a flash memory, and other electronic, magnetic, and/or optical memory devices. The machine-readable device may be a machine-readable medium such as memory 535 of FIG. 5. While memory 535 is shown as a single unit, terms such as “memory,” “memory module,” “machine-readable medium,” “machine-readable device,” and similar terms should be taken to include all forms of storage media, either in the form of a single medium (or device) or multiple media (or devices), in all forms. For example, such structures can be realized as centralized database(s), distributed database(s), associated caches, and servers; one or more storage devices, such as storage drives (including but not limited to electronic, magnetic, and optical drives and storage mechanisms), and one or more instances of memory devices or modules (whether main memory; cache storage, either internal or external to a processor; or buffers). Terms such as “memory,” “memory module,” “machine-readable medium,” and “machine-readable device,” shall be taken to include any tangible non-transitory medium which is capable of storing or encoding a sequence of instructions for execution by the machine and that cause the machine to perform any one of the methodologies taught herein. The term “non-transitory” used in reference to a “machine-readable device,” “medium,” “storage medium,” “device,” or “storage device” expressly includes all forms of storage drives (optical, magnetic, electrical, etc.) and all forms of memory devices (e.g., DRAM, Flash (of all storage designs), SRAM, MRAM, phase change, etc., as well as all other structures designed to store data of any type for later retrieval.

FIG. 5 is a block diagram of features of an embodiment of an example system 500 operable to execute schemes associated with determining status of a structure of multiple strings of pipe in a wellbore. The system 500 can comprise instrumentality as taught herein, for example, in accordance with embodiments described with respect to FIGS. 1-4 or similar arrangements.

The system 500 can comprise a tool 570, having one or more transmitters 515 and an array or receivers 510, and controller(s) 530 to control the one or more transmitters 515 and the array of receivers 510. The controller(s) 530 can be arranged to process data from acoustic energy received by the array of receivers 510 from regions of the wellbore in response to acoustic energy generated by the transmitter(s) 515 to determine status of the structure of multiple strings of pipe in a wellbore and material within the wellbore. The controller(s) 530 can be realized as one or more processors. The controller(s) 530 can be arranged as a single processor or a group of processors. Processors of the group of processors may operate independently depending on an assigned function. The controller(s) 530 can be realized as one or more application-specific integrated circuits (ASICs). The controller(s) 530 can be realized as control circuitry to manage the components of system 500.

The array of receivers 510 can be realized by different acoustic receiver formats. The array of receivers 510 can be an array of hydrophones. The array of receivers 510 can he an array of acoustic sensors coupled to an optical fiber. The array of receivers 510 can be an optical fiber arranged in the system as an array of distributed sensors. The transmitter(s) 515, in addition to having one or more acoustic transmitters, can include optical transmitters, such as a laser, for implementation with the array of acoustic receivers having an optical arrangement.

The controller(s) 530 can be operable to monitor sound energy received in an array of acoustic receivers, the array of acoustic receivers arranged relative to a structure of multiple strings of pipe in a wellbore; segregate frequencies of the received sound energy supplying information of the pipe strings, completion hardware, and/or materials in-between of the structure being sampled by distance and/or frequencies; conduct coherent signal processing of the received sound energy with respect to location; and derive a bond map of the structure and regions around the multiple strings of pipe from completion of the coherent signal processing

The system 500 can include a user interface 562 operable with the controller(s) 530, a signal processing unit 526 operable with the user interface 562, where the controller(s) 530, the user interface 562, and the signal processing unit 526 can be structured to be operated according to any scheme similar to or identical to the schemes associated with determining status of a structure of multiple strings of pipe in a wellbore as taught herein. The system 500 can be arranged as a distributed system.

The system 500 can include a memory 535, an electronic apparatus 550, and a communications unit 540. The controller(s) 530, the memory 535, and the communications unit 540 can be arranged to operate as a signal processing unit to control investigation of a multi-string structure of pipes in a wellbore and material around the pipes. The memory 535 can he realized as a memory module, which may include a set of memory devices and access devices to interface with the set of memory devices. The memory 535 can include a database having information and other data such that the system 500 can operate on data to control the transmitter(s) 515, the array of receivers 510. In an embodiment, the signal processing unit 526 can be distributed among the components of the system 500 including memory 535 and/or the electronic apparatus 550. Alternatively, the signal processing unit 526 can be arranged as an independent system having its own processor(s) and memory. The electronic apparatus 550 can include drivers to provide voltage and/or current input to components of the system 500. For example, the electronic apparatus 550 can include drivers of optical sources, such as lasers and can include electronic circuitry for optical detectors and interferometric devices associated with optical fiber receiver arrangements.

The communications unit 540 may use combinations of wired communication technologies and wireless technologies at appropriate frequencies. The communications unit 540 can allow for a portion or all of data analysis regarding the status of the multi-string pipe structure and associated material in annuli around the pipes to be provided to the user interface 562 for presentation on the one or more display unit(s) 560 aboveground. The communications unit 540 can allow for transmission of commands to downhole components in response to signals provided by a user through the user interface 562.

The system 500 can also include a bus 537, where the bus 537 provides electrical conductivity among the components of the system 500. The bus 537 can include an address bus, a data bus, and a control bus, each independently configured. The bus 537 can be realized using a number of different communication mediums that allows for the distribution of components of the system 500. Use of the bus 537 can be regulated by the controller(s) 530. The bus 537 can include a communications network to transmit and receive signals including data signals and command and control signals. In a distributed architecture, the bus 537 may be part of a communications network.

In various embodiments, peripheral devices 555 can include additional storage memory and/or other control devices that may operate in conjunction with the controllers(s) 530 and/or the memory 535. The display unit(s) 560 can be arranged with a screen display as a distributed component that can be used with instructions stored in the memory 535 to implement the user interface 562 to manage the operation of the tool 570 and/or components distributed within the system 500. Such a user interface can be operated in conjunction with the communications unit 540 and the bus 537. The display unit(s) 560 can include a video screen, a printing device, or other structure to visually project data/information and images. The system 500 can include a number of selection devices 564 operable with the user interface 562 to provide user inputs to operate the signal processing unit 526 or its equivalent. The selection device(s) 564 can include one or more of a touch screen, a computer mouse, or other control device operable with the user interface 562 to provide user inputs to operate the signal processing unit 526 or other components of the system 500.

Systems and methods, as taught herein, can be used in several different ways. Such systems and method can robustly investigate behind several strings of pipe in a wellbore. This may be crucial when performing plug and abandonment work, since it is desirable to know whether certain harriers are to be set within a well to meet regulatory requirements. The techniques, as taught herein, may provide an indication that one or more barriers are set in the appropriated locations.

Systems and methods, as taught herein, can be used to determine if workover is needed by identifying what areas do not have cement and what areas have sufficient cement in the structure of the wellbore. This data allows the avoidance of typical activities that would create issues due to the absence of expected presence of cement in specific areas. identifying where cement is located in a wellbore can address well integrity or well isolation.

The following are example embodiments of methods, systems, and machine readable storage devices, in accordance with the teachings herein.

A processor implemented method 1 can comprise: monitoring sound energy received in an array of acoustic receivers, the array of acoustic receivers arranged relative to a structure of multiple strings of pipe in a wellbore; segregating frequencies of the received sound energy supplying information of the pipe strings, completion hardware, and/or materials in-between of the structure being sampled by distance and/or frequencies; conducting coherent signal processing of the received sound energy with respect to location; and deriving a bond map of the structure and regions around the multiple strings of pipe from completion of the coherent signal processing.

A processor implemented method 2 can include elements of processor implemented method 1 and can include conducting coherent processing of the received sound energy to include generating model beamforming by partitioning the frequencies and magnitude patterns of the received sound energy into locations.

A processor implemented method 3 can include elements of any of processor implemented methods 1 and 2 and can include exciting pipe harmonics of the structure using an acoustic transmitter.

A processor implemented processor implemented method 4 can include elements of any of processor implemented methods 1-3 and can include monitoring sound energy received in the linear array of acoustic receivers to include monitoring sound energy received in an array of hydrophones.

A processor implemented method 5 can include elements of processor implemented method 4 and elements of any of processor implemented methods 1-3 and can include determining bond indices of different regions of the structure using time and frequency responses of the hydrophones,

A processor implemented method 6 can include elements of any of processor implemented methods 1-5 and can include activating one or multiple acoustic transmitters to excite pipe harmonics and materials of the structure from which the sound energy is monitored.

A processor implemented method 7 can include elements of any of processor implemented methods 1-6 and can include activating one or more acoustic transmitters with different frequencies from which the sound energy is monitored.

A processor implemented method 8 can include elements of any of processor implemented methods 1-7 and can include monitoring sound energy received in the array of acoustic receivers to include monitoring sound energy received in an optical fiber sensor arranged as a distributed acoustic sensor.

A processor implemented method 9 can include elements of any of processor implemented methods 1-8 and can include deriving a bond map to include using forward modeling to identify material around pipes of the structure.

A processor implemented method 10 can include elements of any of processor implemented methods 1-9 and can include imaging the bond map on a display.

A machine-readable storage device 1 having instructions stored thereon, which, when executed by one or more processors of a machine, cause the machine to perform operations, the operations comprising monitoring sound energy received in an array of acoustic receivers, the array of acoustic receivers arranged relative to a structure of multiple strings of pipe in a wellbore; segregating frequencies of the received sound energy supplying information of the pipe strings, completion hardware, and/or materials in-between of the structure being sampled by distance and/or frequencies; conducting coherent signal processing of the received sound energy with respect to location; and deriving a bond map of the structure and regions around the multiple strings of pipe from completion of the coherent signal processing.

A machine-readable storage device 2 can include elements of machine-readable storage device 1 and can include conducting coherent processing of the received sound energy to include generating model beamforming by partitioning the frequencies and magnitude patterns of the received sound energy into locations.

A machine-readable storage device 3 can include elements of any of machine-readable storage devices 1 and 2 and can include exciting pipe harmonics of the structure using an acoustic transmitter.

A machine-readable storage device 4 can include elements of any of machine-readable storage devices 1-3 and can include monitoring sound energy received in the linear array of acoustic receivers to include monitoring sound energy received in an array of hydrophones.

A machine-readable storage device 5 can include elements of machine-readable storage device 4 and elements of any of machine-readable storage devices 1-3 and can include determining bond indices of different regions of the structure using time and frequency responses of the hydrophones.

A machine-readable storage device 6 can include elements of any of machine-readable storage devices 1-5 and can include activating one or multiple acoustic transmitters to excite pipe harmonics and materials of the structure from which the sound energy is monitored.

A machine-readable storage device 7 can include elements of any of machine-readable storage devices 1-6 and can include activating one or more acoustic transmitters with different frequencies from which the sound energy is monitored.

A machine-readable storage device 8 can include elements of any of machine-readable storage devices 1-7 and can include monitoring sound energy received in the array of acoustic receivers to include monitoring sound energy received in an optical fiber sensor arranged as a distributed acoustic sensor.

A machine-readable storage device 9 can include elements of any of machine-readable storage devices 1-8 and can include deriving a bond map to include using forward modeling to identify material around pipes of the structure.

A machine-readable storage device 10 can include elements of any of machine-readable storage devices 1-9 and can include imaging the bond map on a display.

A system 1 can comprise: an array of acoustic receivers, the array of acoustic receivers arranged relative to a structure of multiple strings of pipe in a wellbore; and a processor arranged to operate on output of the array of acoustic receivers, the processor operable to segregate frequencies of the received sound energy to indicate a pipe of the structure being sampled by distance and/or frequencies, to conduct coherent signal processing of the received sound energy with respect to location, and to derive a bond map of the structure and regions around the multiple strings of pipe from completion of the coherent signal processing.

A system 2 can include elements of system 1 and can include the processor operable to conduct coherent processing of the received sound energy to include the processor operable to generate model beamforming by partitioning the frequencies and magnitude patterns of the received sound energy into locations.

A system 3 can include elements of any of systems 1 and 2 and can include one or multiple acoustic transmitters to excite pipe harmonics and materials of the structure.

A system 4 can include elements of any of systems 1-3 and can include one or more acoustic transmitters operable at different frequencies.

A system 5 can include elements of any of systems 1-4 and can include the array of acoustic receivers to include a linear array of hydrophones.

A system 6 can include elements of system 5 and elements of any of systems 1-4 and can include the processor arranged to determine bond indices of different regions of the structure using time and frequency responses of the hydrophones.

A system 7 can include elements of any of systems 1-6 and can include the array of acoustic receivers to include an optical fiber sensor arranged as a distributed acoustic sensor.

A system 8 can include elements of any of systems 1-7 and can include the processor operable to derive a bond map to include the processor operable to use forward modeling to identify material around pipes of the structure.

A system 9 can include elements of any of systems 1-8 and can include a display on which to image the bond map.

A system 10 can include elements of any of systems 1-9 and can include the processor to include a plurality of processing devices.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. it is to be understood that the above description is intended to be illustrative, and not restrictive, and that the phraseology or terminology employed herein is for the purpose of description. Combinations of the above embodiments and other embodiments will be apparent to those of skill in the art upon studying the above description.

1. A processor implemented method comprising:
monitoring sound energy received in an array of acoustic receivers, the array of acoustic receivers arranged relative to a structure of multiple strings of pipe in a wellbore;
segregating frequencies of the sound energy supplying information of the multiple strings of pipe, completion hardware, and/or materials in-between of the structure being sampled by distance and/or frequencies;
conducting coherent signal processing of the sound energy with respect to location; and
deriving a bond map of the structure and regions around the multiple strings of pipe from completion of the coherent signal processing.

2. The processor implemented method of claim 1, wherein conducting coherent processing of the received sound energy includes generating model beamforming by partitioning the frequencies and magnitude patterns of the received sound energy into locations.

3. The processor implemented method of claim 1, wherein the method includes exciting pipe harmonics of the structure using an acoustic transmitter.

4. The processor implemented method of claim 1,
wherein monitoring sound energy received in the array of acoustic receivers includes monitoring sound energy received in an array of hydrophones,
wherein the method includes determining bond indices of different regions of the structure using time and frequency responses of the array of hydrophones.

5. (canceled)

6. The processor implemented method of claim 1, wherein the method includes activating one or multiple acoustic transmitters to excite pipe harmonics and materials of the structure from which the sound energy is monitored.

7. The processor implemented method of claim 1, the method includes activating one or more acoustic transmitters with different frequencies from which the sound energy is monitored.

8. The processor implemented method of claim 1, wherein monitoring sound energy received in the array of acoustic receivers includes monitoring sound energy received in an optical fiber sensor arranged as a distributed acoustic sensor.

9. The processor implemented method of claim 1, wherein deriving the bond map includes using forward modeling to identify material around pipes of the structure.

10. The processor implemented method of claim 1, wherein the method includes imaging the bond map on a display.

11. (canceled)

12. A system comprising:
an array of acoustic receivers, the array of acoustic receivers arranged relative to a structure of multiple strings of pipe in a wellbore and to receive sound energy; and
a processor arranged to operate on output of the array of acoustic receivers, the processor operable to segregate frequencies of the sound energy to indicate a pipe of the structure being sampled by distance and/or frequencies, to conduct coherent signal processing of the sound energy with respect to location, and to derive a bond map of the structure and regions around the multiple strings of pipe from completion of the coherent signal processing.

13. The system of claim 12, wherein the processor operable to conduct coherent processing of the sound energy includes the processor operable to generate model beamforming by partitioning the frequencies and magnitude patterns of the sound energy into locations.

14. The system of claim 12, wherein the system includes one or multiple acoustic transmitters to excite pipe harmonics and materials of the structure and operable at different frequencies.

15. (canceled)

16. The system of claim 12,
wherein the array of acoustic receivers includes a linear array of hydrophones, and
wherein the processor is arranged to determine bond indices of different regions of the structure using time and frequency responses of the linear array of hydrophones.

17. (canceled)

18. The system of claim 12, wherein the array of acoustic receivers includes an optical fiber sensor arranged as a distributed acoustic sensor.

19. The system of claim 12, wherein the processor operable to derive the bond map includes the processor operable to use forward modeling to identify material around pipes of the structure.

20. The system of claim 12, wherein the system includes a display on which to image the bond map.

21. The system of claim 12, wherein the processor includes a plurality of processing devices.

22. A machine-readable storage medium having instructions stored thereon, which, when executed by a processor, cause the processor to perform operations comprising:
monitoring sound energy received in an array of acoustic receivers, the array of acoustic receivers arranged relative to a structure of multiple strings of pipe in a wellbore;
segregating frequencies of the sound energy supplying information of the multiple strings of pipe, completion hardware, and/or materials in-between of the structure being sampled by distance and/or frequencies;
conducting coherent signal processing of the sound energy with respect to location; and
deriving a bond map of the structure and regions around the multiple strings of pipe from completion of the coherent signal processing.

23. The machine-readable medium of claim 22, wherein the conducting coherent processing of the received sound energy includes generating model beamforming by partitioning the frequencies and magnitude patterns of the received sound energy into locations.

24. The machine-readable medium of claim 22, wherein the operations comprise activating one or multiple acoustic transmitters to excite pipe harmonics and materials of the structure from which the sound energy is monitored.
